(19) United States
(12) Patent Application Publication
(10) Pub. No.: US 2007/0159340 A1
(43) Pub. Date: Jul. 12, 2007

(54) Structure and method for packaging radio frequency identification devices

(75) Inventors: Kuo-Tung Chiang, Bali Township (TW); Shun-Chi Chang, Taipei (TW); Chun-Ping Wu, Sinjhuang City (TW); Mei-Yi Wu, Taipei (TW); Cheng-Hsien Chou, Taipei City (TW); Mong-Tai Yang, Xiahi City (TW); Min Shun Wu, Tucheng City (TW)

Correspondence Address: Howard Chen, Esq.;Kirkpatrick & Lockhart Preston Gates Ellis LLP, Suite 1700, 55 Second Street, San Francisco, CA, 94150, US

(73) Assignee: YUEN FOONG YU PAPER MFG. CO., LTD.

(21) Appl. No.: 11/651,325

(22) Filed: Jan. 9, 2007

Related U.S. Application Data
(60) Provisional application No. 60/757,338, filed on Jan. 9, 2006.

(51) Int. Cl. G08B 13/14

(52) U.S. Cl. 340/572.8

(57) ABSTRACT

A structure for packaging a radio frequency identification (RFID) device is disclosed, which comprises a substrate, an antenna formed on the substrate, a RFID chip with a first side attached to the substrate and a second side having at least one signal pin exposed, at least one conductive contact plate placed on the substrate in contact with both the exposed signal pin and a portion of the antenna, and a protective film over the contact plate to secure the same to the substrate, wherein an electrical connection between the signal pin and the portion of the antenna is made through the contact plate.

### CROSS REFERENCE

The present application claims the benefit of U.S. Provisional Application Ser. No. 60/757,338, which was filed on Jan. 9, 2006, and titled “Method and System for Packaging RFID Devices”.

### BACKGROUND

The present invention relates generally to packaging of microelectronic devices, and more specifically to packaging of radio frequency identification devices.

Most integrated circuits are manufactured on silicon substrate, and packaged in either plastic or ceramic material. These materials are rigid, relatively bulky and expensive for the manufacturing processes. But in certain applications, flexibility and low cost are of major concern. Radio frequency identification (RFID) devices are one of such applications. They have to be flexible enough to be attached to any surface, and cost low enough to compete with bar codes in merchandize management.

In general, there are three directions of technical development in order to realize the idea of flexible electronics. The first is to lower the temperature of current semiconductor production process, manufacturing transistors directly onto the plastic substrates. The second is to etch and to attach the electronic components, which are located on glass or silicon substrates, onto plastic substrates, in a process similar to the principle of printing boards. The third is to, with the use of new organic materials, produce organic thin-film transistor (OTFT) via printing or inkjet method.

Substrates for RFID devices are conventional soft material, such as paper or plastic. An antenna is first formed on the substrate by either printing, copper film etching or electron plating method. Then a RFID chip is fixed onto the antenna by gold wire welding or flip chip. Peel-to-peel process is normally used during the packaging and the manufacturing processes of RFID devices, which can be produced quickly in large quantities. But extra caution must be made on the alignment of the chips, ensuring the signal pins of the chips can accurately match the feed point on the antenna. Otherwise an additional welding manufacturing process must be implemented with gold wire welding, which reduces the speed of packaging and increase complexity of the manufacturing process.

How to rapidly and accurately carry out the packaging manufacturing process has become a very important issue in the production of radio frequency identification devices.

As such, what is desired is a rapid and accurate packaging manufacturing process for the RFID devices.

### SUMMARY

In view of the foregoing, the present invention provides a structure for packaging a RFID device. According to one aspect of the invention, the structure comprises a substrate, an antenna formed on the substrate, a RFID chip with a first side attached to the substrate and a second side having at least one signal pin exposed, at least one conductive contact plate placed on the substrate in contact with both the exposed signal pin and a portion of the antenna, and a protective film over the contact plate to secure the same to the substrate, wherein an electrical connection between the signal pin and the portion of the antenna is made through the contact plate.

According to another aspect of the present invention, the contact plate is attached to a substrate forming a connector strip prior to placing the contact plate on the signal pin and the portion of the antenna.

The construction and method of operation of the invention, however, together with additional objects and advantages thereof will be best understood from the following description of specific embodiments when read in connection with the accompanying drawings.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore non-limiting, embodiments illustrated in the drawings, wherein like reference numbers (if they occur in more than one view) designate the same elements. The invention may be better understood by reference to one or more of these drawings in combination with the description presented herein. It should be noted that the features illustrated in the drawings are not necessarily drawn to scale.

FIGS. 1A˜1C are a top and two side views, respectively, of a RFID device with an antenna formed on a substrate.

FIGS. 2A and 2B are a top and side views, respectively, of the RFID device with a RFID chip attached on the substrate.

FIGS. 2C and 2D are a bottom and side views, respectively, of a connector strip with two contact plates.

FIGS. 3A and 3B are a top and side views, respectively, of the RFID device with the connector strip applied according to one embodiment of the present invention.

FIG. 4A and 4B are a top and side views, respectively, of the RFID device with a protective film applied.

### DESCRIPTION

The following will provide a detailed description of a structure and method for packaging a radio frequency identification (RFID) device.

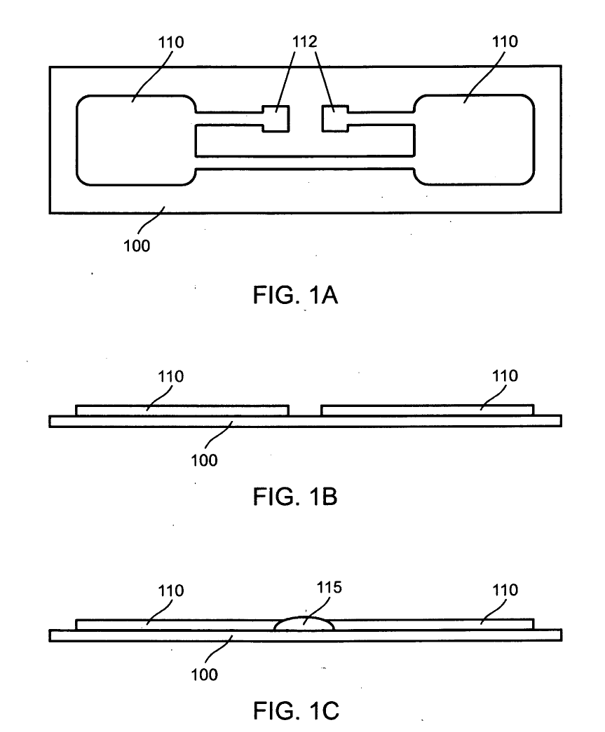

FIGS. 1A˜1C are a top and two side views, respectively, of a RFID device with an antenna 110 formed on a substrate 100. FIG. 1A is a top view of the RFID device. The antenna 110 has two contact pads 112 for making electrical connections to a RFID chip. The substrate 100 is a thin film made of a plastic material such as plastic or paper. The antenna 110 is made of conductive material and attached to the substrate 100. There are numerous manufacturing processes to form such antenna 110. A first manufacturing process is to attach a copper foil on the substrate 100, followed by an etching process to form a pattern of the antenna 110. A second manufacturing process is to print conductive silver or carbon ink on the substrate 100 in a desired antenna pattern as shown in FIG. 1, followed by electroplating a layer of thin copper film. A third manufacturing process is to vacuum evaporate a thin layer of copper film directly onto the substrate 100. A fourth manufacturing process is to hot stamp a conductive ink onto the substrate 100. A fifth manufacturing process is to duplicate a pattern of the antenna 110 onto the substrate 100 through offset lithography, gravure printing, letterpress printing, screen printing or inkjet printing process.

FIG. 1B is a side view of the RFID device after the antenna 110 is attached onto the substrate 100. Then an adhesive material 115 is applied onto a location of the substrate 100 where a RFID chip is to be attached, as shown in FIG. 1C.

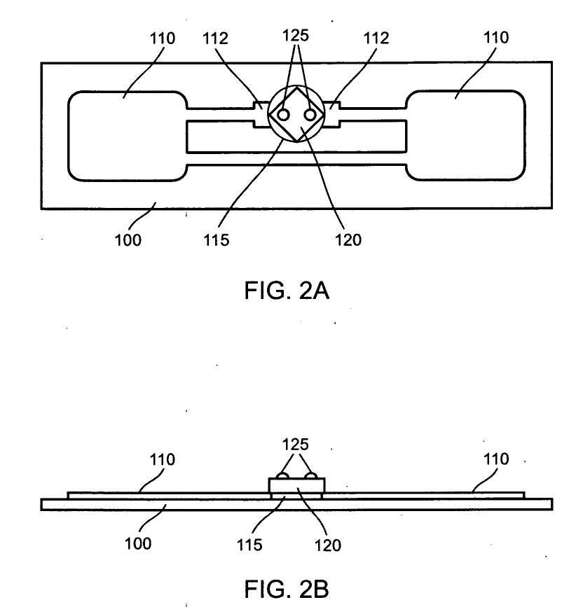

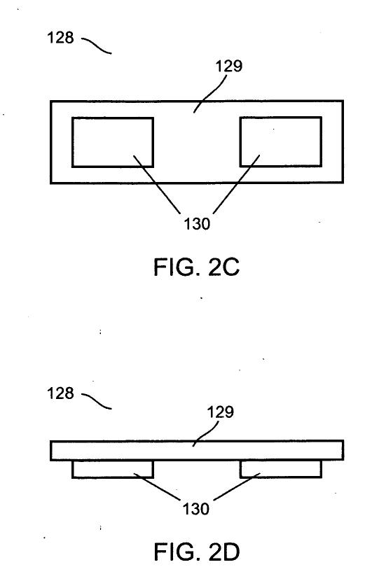

FIGS. 2A and 2B are a top and side views, respectively, of the RFID device with a RFID chip 120 attached onto the substrate 100. The RFID chip 120 has two signal pins 125 facing upward when placed on the substrate 100. The two signal pins 125 must be aligned with the two contact pads 112 of the antenna 110, respectively, so that the distance between a signal pin 125 and its respective contact pad 112 is the shortest. One of the signal pins 125 is for an input of the RFID chip 120 and the other for output. Since the RFID chip 120 is attached to the substrate 100 by adhesion, a manufacturing process for applying the RFID chip 120 does not require complex steps or any additional process.

FIGS. 2C and 2D are a bottom and side views, respectively, of a connector strip 128 with a substrate 129 and two contact plates 130. The substrate 129 is made of a flexible material such as plastic or paper. The contact plates 130 is used to connect a signal pin 125 to a respective contact pad 112, therefore, they are made of a conductive material such as copper, and are sized enough to make contact with an adjacent pair of contact pad 112 and signal pin 125. Similar to the antenna manufacturing process described above, the connector strip 128 may also be manufactured by metal etching, conductive ink printing, vacuum evaporating or conductive ink hot stamping.

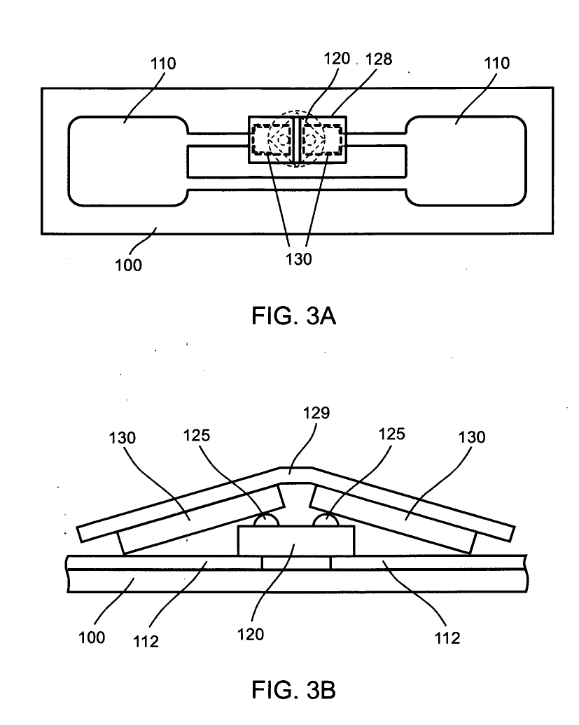

FIGS. 3A and 3B are a top and side views, respectively, of the RFID device with the connector strip 128 applied according to one embodiment of the present invention. Referring to FIG. 3A, the connector strip 128 is placed right on top of the RFID chip 120. Referring to FIG. 3B, the connector strip 128 is placed with the contact plate 130 facing downward. One of the contact plates 130 comes into contact with a signal pin 125 of the RFID chip 120 and a neighboring contact pad 112 of the antenna 100, therefore creates an electrical connection between the two. The other contact plate 130 makes an identical connection between the other neighboring signal pin 125 and contact pad 112. Apparently, if the sizes of the contact plates 130 are made large enough, there will be less need for stringent alignment between the neighboring signal pin 125 and contact pad 112. Both the manufacturing process and the application method of the connector strip 128 makes it a cost effective and mass producible solution to make connection between the RFID chip 120 and the antenna 110.

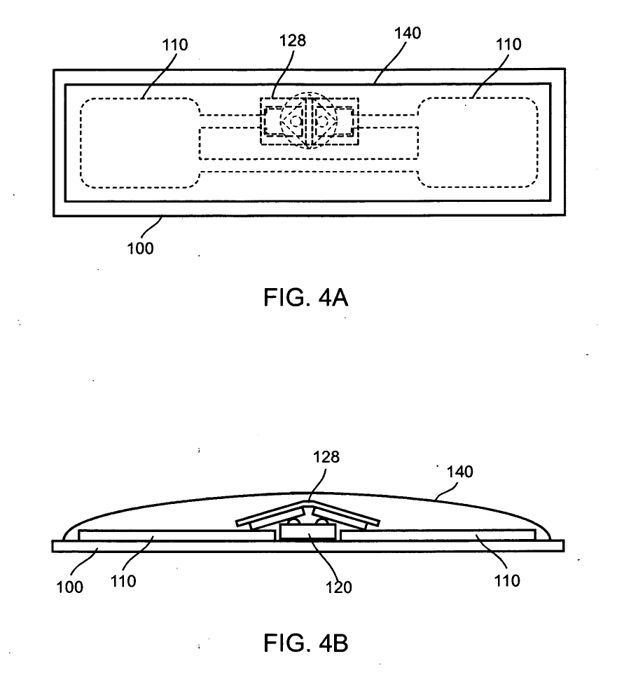

FIG. 4A and 4B are a top and side views, respectively, of the RFID device with a protective film 140 applied. After the connector strip 128 is placed on the substrate 100, makes proper electrical connections between the neighboring signal pin 125 and the contact pad 112, the protective film 140 is applied over the connector strip 128, as well as the entire antenna 110 area. The protective film 140 is adhesive or can be laminated to the substrate 100. Therefore, the connector strip 128 is secured in the place to make the proper electrical connections by the protective film 140. The material for making the protective film 140 may be transparent plastic that can be laminated to the substrate 100, or any other materials as long as they can be securely attached to the substrate 100 and do not interfere with transmissions of radio frequency electromagnetic signals. It is even possible that ink markings may be printed on the protective film after the RFID device is completely assembled.

Although the embodiment of the present invention described above employs a substrate 129 to support the contact plate 130 in forming the connector strip 128, one having skills in the art would realize that a bare metal foil may be placed directly in contact with the signal pin 125 and the contact pad 112. The subsequent protective film 140 serves to both secure the metal foil to the substrate 100 and protect the metal foil from being damaged in later processes or in application fields.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A packaging structure for a radio frequency identification (RFID) device, the packaging structure comprising:
a substrate;
an antenna formed on the substrate;
a RFID chip with a first side attached to the substrate and a second side having at least one signal pin exposed;
at least one conductive contact plate placed on the substrate in contact with both the exposed signal pin and a portion of the antenna; and
a protective film over the contact plate to secure the same to the substrate, wherein an electrical connection between the signal pin and the portion of the antenna is made through the contact plate.

2. The packaging structure of claim 1, wherein the substrate is made of one or more flexible materials.

3. The packaging structure of claim 1, wherein the antenna is formed by a copper etching process.

4. The packaging structure of claim 1, wherein the antenna is formed by a conductive material printing process.

5. The packaging structure of claim 1, wherein the antenna is formed by a hot stamping process.

6. The packaging structure of claim 1, wherein the RFID chip is attached to the substrate by an adhesive material.

7. The packaging structure of claim 1 further comprising a flexible strip to which the contact plate is attached.

8. The packaging structure of claim 7, wherein the contact plate is formed through a copper etching process.

9. The packaging structure of claim 7, wherein the contact plate is formed by a conductive material printing process.

10. The packaging structure of claim 7, wherein the contact plate is formed by a hot stamping process.

11. The packaging structure of claim 1, wherein the protective film covers substantially the entire antenna.

12. A packaging structure for a radio frequency identification (RFID) device, the packaging structure comprising:
a substrate;
an antenna formed on the substrate;
a RFID chip with a first side attached to the substrate and a second side having at least one signal pin exposed;
a flexible connector strip with at least one conductive contact plate attached thereto, wherein the contact plate is in contact with both the exposed signal pin and a portion of the antenna; and
a protective film over the connector strip to secure the same to the substrate,
wherein an electrical connection between the signal pin and the portion of the antenna is made through the contact plate.

13. The packaging structure of claim 12, wherein the substrate is made of one or more flexible materials.

14. The packaging structure of claim 12, wherein the antenna is formed by a copper etching process.

15. The packaging structure of claim 12, wherein the antenna is formed by a conductive material printing process.

16. The packaging structure of claim 12, wherein the antenna is formed by a hot stamping process.

17. The packaging structure of claim 12, wherein the RFID chip is attached to the substrate by an adhesive material.

18. The packaging structure of claim 12, wherein the contact plate is attached to the connector strip through a copper etching process.

19. The packaging structure of claim 12, wherein the contact plate is attached to the connector strip by a conductive material printing process.

20. The packaging structure of claim 12, wherein the contact plate is attached to the connector strip by a hot stamping process.

21. The packaging structure of claim 12, wherein the protective film covers substantially the entire antenna.

22. A method for packaging a radio frequency identification (RFID) device, the method comprising:
providing a substrate;
forming an antenna on the substrate;
attaching a RFID chip to the substrate with at least one signal pin facing away from the substrate and being exposed;
placing a connector strip with at least one conductive contact plate attached thereto in a location where the contact plate is in contact with both the exposed signal pin and a portion of the antenna.
applying a protective film over the connector strip to secure the same to the substrate,
wherein an electrical connection between the signal pin and the portion of the antenna is made through the contact plate.

23. The method of claim 22, wherein the forming the antenna comprises:
attaching a copper foil on the substrate; and
etching away the copper in unwanted areas to form an antenna pattern.

24. The method of claim 22, wherein the forming the antenna comprises printing at least one conductive material on the substrate in a predetermined antenna pattern.

25. The method of claim 22, wherein the attaching the RFID chip comprises:
applying an adhesive material on the substrate in a predetermined location; and
placing the RFID chip on the adhesive material.

26. The method of claim 22 further comprising applying the protective film over substantially the entire antenna area.
